(19) United States
(12) Patent Application Publication
(10) Pub. No.: US 2019/0130482 A1
(43) Pub. Date: May 2, 2019

(54) PEER TO PEER LOAN SYSTEM AND PROCESS

(71) Applicant: MOOCH IT PTY LTD, Queensland, OT (AU)

(72) Inventor: Aaron MORRIS, QUEENSLAND (AU)

(21) Appl. No.: 16/094,891

(22) PCT Filed: Apr. 20, 2017
(86) PCT No.: PCT/AU2017/050354

§ 371 Date: Oct. 19, 2018

(30) Foreign Application Priority Data
Apr. 21, 2016 (AU) 2016100440

(51) Int. Cl. G06Q 40/02; G06Q 20/22; G06Q 20/40; G06F 16/182

(52) U.S. Cl. CPC G06Q 40/025; G06F 16/1834; G06Q 20/401; G06Q 20/223

(57) ABSTRACT

A peer-to-peer loan facilitation system. A first electronic device creates a lending bid or borrowing request specifying one or more terms and conditions for a financial loan. A second electronic device generates search criteria for a lending bid or a borrowing request including one or more terms and conditions for a financial loan. A server receives from the first electronic device the lending bid or borrowing request, receives from the second electronic device the search criteria, and matches the search criteria to the lending bid or borrowing request if the one or more terms and conditions of the search criteria are similar to those of the lending bid or borrowing request. The server facilitates the exchange of electronic correspondence between the first electronic device and the second electronic device. A database connected to the server records the electronic correspondences exchanged between the first electronic device and the second electronic device.

### FIELD OF INVENTION

The present invention relates to systems and processes for arranging and effecting loans. The present invention has particular but not exclusive application in arranging and effecting peer-to-peer loans between two individuals, absent the involvement of a financial institution in financing the loan.

### BACKGROUND OF THE INVENTION

Individuals seeking financial loans have typically had to rely on established financial institutions such as banks to provide loans. The balance of power and leverage in the relationship between an individual and a financial institutions is heavily weighted in favour of the financial institutions, who decide on the terms, conditions, interest rates, limits, approval, and the like.

Accordingly, the ability for an individual to obtain a loan that is bespoke or otherwise better suited to their needs is limited. This is particularly the case when the loan amount is small, for a short period of time, and/or if the individual has an imperfect credit rating and credit history.

Additionally, individuals seeking to use their savings to provide loans in return for interest earnings have typically only had established financial institutions readily available as borrowers. The financial institutions act as borrowers by way of providing “savings accounts” for the individuals to store their money in, and which “savings accounts” in return pay to the individuals an amount of interest.

Again, the balance of power and leverage in the relationship between the individual and the financial institution is heavily weighted in favour of the financial institution, which decides on the terms, conditions, interest rates, and the like.

The ability for individuals with savings to lend to individuals who have a need for a loan, and vice versa, is presently almost non-existent. The ability to do so is hindered by potential lenders and potential borrowers not being able to find each other, the lack of security (predominantly for the lender), difficulty in generating and maintaining official records, and the sense of having no support if and when things go wrong.

### OBJECT OF THE INVENTION

There is a need for a system and a process that match potential borrowers to potential lenders, and which allow for borrowers and/or lenders to have flexibility in setting and negotiating preferred terms, conditions, and other characteristics of a loan. There is further a need for a system and process that facilitate the provision of a loan form a lending individual to a borrowing individual in a manner that encourages all parties involved to act candidly and in good faith, and facilitates a level of support if and when disagreements arise between the involved parties.

It is therefore one object of the present invention to provide an electronic system and corresponding process for realizing the matching of borrowing individuals and lending individuals, and facilitating and managing an agreement between the borrowing and lending individuals in a manner that assists all involved parties to abide by the terms of the agreement.

### SUMMARY OF THE INVENTION

According to one aspect of the present invention, a peer-to-peer loan facilitation system comprises a first electronic device configured to create a lending bid or borrowing request, the lending bid or borrowing request specifying one or more terms and conditions for the provision of a financial loan; a second electronic device configured to generate a search criteria for a lending bid or a borrowing request, the search criteria including one or more terms and conditions for the provision of a financial loan; a server configured to receive from the first electronic device the lending bid or borrowing request, receive from the second electronic device the search criteria, and match the search criteria to the lending bid or borrowing request if the one or more terms and conditions of the search criteria are similar to those of the lending bid or borrowing request, wherein the server is further configured to facilitate the exchange of electronic correspondence between the first electronic device and the second electronic device; and a database connected to the server and configured to record therein the electronic correspondences exchanged between the first electronic device and the second electronic device.

In one form, the second electronic device is operable to send to the first electronic device, via the server, an electronic correspondence indicative of an acceptance of the lending bid created by the first electronic device.

In one form, the second electronic device is operable to send to the first electronic device, via the server, an electronic correspondence proposing revisions to the one or more terms and conditions specified by the lending bid created by the first electronic device.

In one form, the first electronic device is operable to send to the second electronic device, via the server, an electronic correspondence indicative of an acceptance of the borrowing request created by the second electronic device.

In one form, the first electronic device is operable to send to the second electronic device, via the server, an electronic correspondence proposing revisions to the one or more terms and conditions specified by the borrowing request created by the second electronic device.

Preferably, the server is further configured to generate a repayment schedule, the repayment schedule identifying one or more of the date and sum of each repayment to be made in accordance with the terms and conditions of the lending bid, and wherein the repayment schedule is stored in one or more of the first electronic device and second electronic device as an electronic reminder for each repayment.

Preferably, the peer-to-peer loan facilitation system further comprises a portal connected to the server, the portal connecting the first electronic device and second electronic device to one or more financial systems, whereby a transfer of funds between a lender and a borrower is facilitated.

In one form, the search criteria generated by the second electronic device is in the form of a lending bid or borrowing request.

In one form, upon identification of a deviation from the repayment schedule, the server generates a new schedule of repayments, the new schedule being generated based on the one or more terms and conditions.

In one form, upon identification of a deviation from the repayment schedule, the server notifies the first electronic device and the second electronic device of the deviation, and facilitates communication between the first and second electronic devices to revise the one or more terms and conditions.

According to a second aspect of the present invention, a peer-to-peer lending process comprises the steps of generating a lending bid or borrowing request on a first electronic device, the lending bid or borrowing request specifying one or more terms and conditions for the provision of a financial loan; generating a search criteria for a lending bid or a borrowing request, the search criteria including one or more terms and conditions for the provision of a financial loan; receiving the lending bid or borrowing request and the search criteria at a server, and matching in the server the lending bid or borrowing request to the search criteria if the one or more terms and conditions of the search criteria are similar to those of the lending bid or borrowing request; exchanging electronic messages between the first electronic device and second electronic device via the server, and recording the electronic messages in a databases; and transferring funds between an operator of the first electronic device and an operator of the second electronic device, whereby a financial loan between the operator of the first electronic device and the operator of the second electronic device is effected.

Preferably, the peer-to-peer lending process further comprises a step of generating a repayment schedule, the repayment schedule identifying one or more of the date and sum of each repayment to be made in accordance with the terms and conditions of the lending bid, and storing in one or more of the first electronic device and second electronic device an electronic reminder for each repayment.

The above aspects, variations, and options are to be understood as comprisable within the invention singly, or in combination with each other.

### BRIEF DESCRIPTION OF THE DRAWINGS

In order that the present invention can be more readily understood, reference will now be made to the accompanying drawings which illustrate preferred embodiments of the invention and wherein:

FIG. 1 illustrates a loan facilitation system according to the present invention; and

FIG. 2 illustrates a loan facilitation process according to the present invention.

### DETAILED DESCRIPTION OF PREFERRED EMBODIMENTS

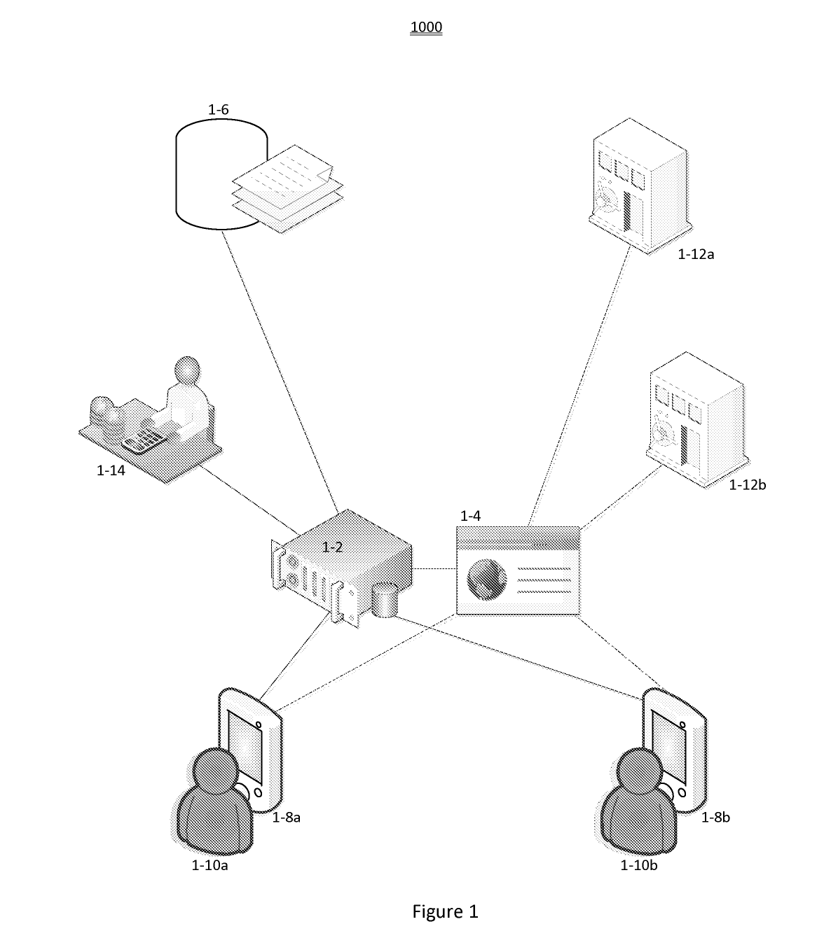

With reference to FIG. 1, a loan facilitation system 1000 according to a first aspect of the present invention is described.

The loan facilitation system 1000 comprises a facilitation server 1-2, and a document database 1-6 connected to the facilitation server 1-2. A lending device 1-8a operated by a lending individual 1-10a and a borrowing device 1-8b operated by a borrowing individual 1-10b are also connected to the facilitation server 1-2. Connection of the lending device 1-8a and borrowing device 1-8b to the facilitation server 1-2 is effected by way of a loan facilitation application executed on each of the devices 1-8a, 1-8b.

According to a preferred embodiment of the present invention, a transaction portal 1-4 is also connected to the facilitation server 1-2. The transaction portal 1-4, as will be described in greater detail below, provides the lending device 1-8a with a direct and/or indirect connection to the electronic financial system 1-12a of a financial institution with which the lending individual 1-10a has an account. Similarly, the transaction portal 1-4, as will be described in greater detail below, provides the borrowing device 1-8b with a direct and/or indirect connection to the electronic financial system 1-12b of a financial institution with which the borrowing individual 1-10b has an account.

Further, in accordance with the preferred embodiment, one or more dispute resolution entities 1-14 is connected to the facilitation server 1-2, and thereby to portions of the document database 1-6.

The facilitation server 1-2 of the present invention generates and stores therein user accounts for each of the borrowing individual 1-10b, the lending individual 1-10a, and the one or more dispute resolution entities 1-14. User accounts for the lending and borrowing individuals 1-10a, 1-10b each record information relevant to and likely required for the provision and/or acceptance of a loan. Such information includes, but is not limited to, name, address, age, contact details, bank account details, proof of credit history, proof of identity, criminal history, verified digital signatures, lending rating, and borrowing rating. User accounts for the one or more dispute resolution entities 1-14 record one or more of contact details for the entities 1-14, access rights to the document database 1-6, services offered, and reputation rating.

The facilitation server 1-2 further stores, in association with each user account, one or more lending bids or borrowing requests as they are created by respective users. Each lending bid stipulates the terms and conditions on which a lending individual 1-10a will provide a loan. Similarly, each borrowing request stipulates the terms and conditions on which a borrowing individual 1-10b wants a loan. The facilitation server 1-2 is configured to match lending bids and borrowing requests that have similar terms and conditions. Additionally, the facilitation server 1-2 is operable to search lending bids and borrowing requests stored therein on demand by users and in accordance with one or more search criteria set by the users.

The transaction portal 1-4 is provided by the facilitation server 1-2 and serves to connect the electronic financial systems 1-12a, 1-12b with the lending and borrowing individuals 1-10a, 1-10b from within the loan facilitation system 1000. The transaction portal 1-4 is, in one example, a POLiPayments™ compatible portal, a PayPal™ compatible portal, and/or a Visa™/Mastercard™ Checkout™ compatible portal. The transaction portal 1-4 integrates the electronic financial systems 1-12a, 1-12b with the loan facilitation system 1000, thereby removing the need for the lending individual 1-10a and borrowing individual 1-10b to leave the loan facilitation system 1000 to separately access the electronic financial systems 1-12a, 1-12b. Additionally, the portal 1-4 in integrating the electronic financial systems 1-12a, 1-12b with the loan facilitation system 1000, allows records/receipts of financial transactions conducted between the lending individual 1-10a, borrowing individual 1-10b, and electronic financial systems 1-12a, 1-12b to be recorded in the document database 1-6, which will now be described in greater detail.

The document database 1-6 records therein information exchanged between the lending individual 1-10a, borrowing individual 1-10b, and electronic financial systems 1-12a, 1-12b (where available) in the setup, conduct, and discharge of a loan between the lending individual 1-10a and borrowing individual 1-10b. Such information includes, but is not limited to:

Message/Correspondence history

Finalized offer of terms and conditions

Acceptance of finalized offer of terms and conditions

Receipts of fund transfers

Receipts of repayments

Renegotiated terms and conditions

The information recorded in the document database 1-6 serves as one source of a paper trail and proof of a loan arrangement between the lending individual 1-10a and the borrowing individual 1-10b. Preferably, information recorded in the document database 1-6 is assigned one or more security settings, which security settings determines which of the one or more dispute resolution entities 1-14 assigned to a dispute resolution event may access said information if/when a dispute resolution event is commenced.

The electronic financial systems 1-12a, 1-12b are 3^{rd} party financial systems that effect fund transfers. Typically, the electronic financial systems 1-12a, 1-12b belong to banks, credit institutions (e.g. Visa™, Mastercard™), and other electronic payment entities (e.g. PayPal™). In the preferred embodiment, the electronic financial systems 1-12a, 1-12b are integrated with the loan facilitation system 1000 by the transaction portal 1-4 such that the electronic financial systems 1-12a, 1-12b are seamlessly accessible and operable from within the loan facilitation system 1000 to effect fund transfers.

The lending device 1-8a and borrowing device 1-8b operated respectively by the lending individual 1-10a and borrowing individual 1-10b are network compatible electronic devices. Preferably, the devices 1-8a, 1-8b are mobile electronic devices such as a tablet or smartphone, executing thereon a proprietary application configured to connect to and interact with the facilitation server 1-2. However, the devices 1-8a, 1-8b, may also be non-mobile electronic devices such as a desktop computer, and may alternatively also connect to and interact with the facilitation server 1-2 by way of a web browser.

The dispute resolution entities 1-14 are entities recommended by, or who have a relationship with, the loan facilitation system 1000 for providing dispute resolution services such as arbitration between a lending individual 1-10a and a borrowing individual 1-10b, legal services, debt collection services, and the like. Depending on the services offered, the dispute resolution entities 1-14 may be provided access to specific information recorded in the document database 1-6, preferably on a need-to-know basis.

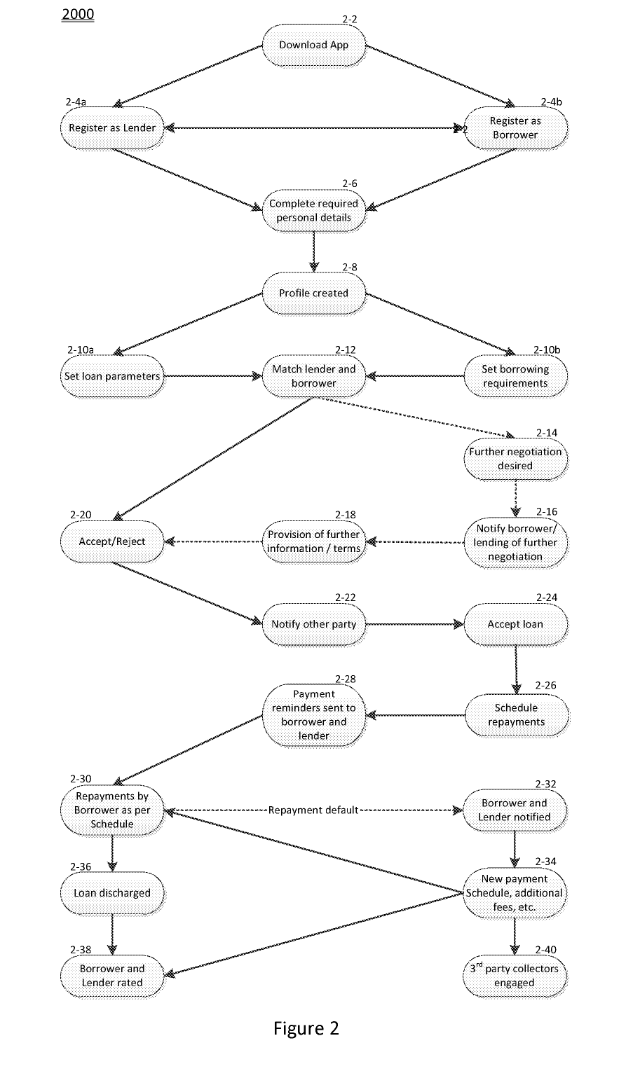

With reference to FIG. 2, a loan facilitation process 2000 and an operation of the loan facilitation system 1000 is described.

The loan facilitation process 2000 commences at 2-2 of FIG. 2, where individuals 1-10a, 1-10b download the aforementioned proprietary application for execution on respective electronic devices 1-8a, 1-8b. Upon execution, the proprietary application connects over a network, for example the Internet, to the facilitation server 1-2. Alternatively, in lieu of the aforementioned proprietary application, a web browser may be utilized to connect to the facilitation server 1-2.

At 2-4a and 2-4b, if the individuals 1-10a, 1-10b have not previously registered with the facilitation server 1-2, the individuals are prompted to register as a lender and/or a borrower. Conversely, if the individuals 1-10a, 1-10b have previously registered, the process may skip to 2-10a, 2-10b, and/or 2-12. To register as a lender and/or borrower, the individuals 1-10a, 1-10b are prompted for personal details (2-6), after which entry a profile is created in the facilitation server 1-2 for each individual 1-10a, 1-10b.

For the purposes of convenient description, it is assumed that individual 1-10a registered as an lending individual, and individual 1-10b registered as a borrowing individual. It is to be understood, however, that the invention is not limited in this manner, and that the same individual can be registered as both a lending individual and a borrowing individual.

At 2-10a the lending individual 1-10a creates a lending bid. Creation of the lending bid, in the preferred embodiment, is effected by way of the proprietary application, which provides a prescribed bid template for the lending individual 1-10a to complete. The bid template, in one form, includes input fields for loan characteristics such as:

Lending amount/range

Lending term/range

Interest rate

Required borrower characteristics, for example:
Minimum salary
Minimum credit rating
Minimum borrowing rating
Criminal history
Required proof of identity

Accepted fund transaction means (e.g. bank cheque, cash, PayPaI™)

Repayment terms (e.g. lump sum, interest only, principal and interest)

Default terms

Custom terms and conditions

In the preferred embodiment, the bid template allows for conditional bid information to be inputted. Conditional bid information is information that allows one or more loan characteristics to vary depending on one or more other loan characteristics. For example, the interest rate may vary depending on the loan amount, loan term, borrower's credit rating, and/or borrower's borrowing rating. Once all necessary and/or desired loan characteristics are entered into the bid template, the lending individual 1-10a finalizes the lending bid, and the loan facilitation process 2000 proceeds to 2-12.

At 2-10b the borrowing individual 1-10b creates a borrowing request. Creation of the borrowing request, in the preferred embodiment, is effected by way of the proprietary application, which provides a prescribed request template for the borrowing individual 1-10b to complete. The borrowing template, in one form, includes input fields for borrowing characteristics such as

Borrowing amount/range

Borrowing term/range

Interest rate

Required lender characteristics, for example:
Minimum lending rating

Accepted fund transaction means (e.g. bank cheque, cash, PayPal™)

Repayment terms (e.g. lump sum, interest only, principal and interest)

Default terms

Custom terms and conditions

After a lending bid or a borrowing request is created, the process 2000 may automatically proceed 1 to 2-12, where a search for closely or identically matching lending bids and borrowing requests is performed. Alternatively, the lending individual 1-10a or borrowing individual 1-10b may initiate a custom and/or manual search, where borrowing criteria or lending criteria are manually specified. Regardless, a search for borrowing request and/or lending bids matching a given criteria is performed, and results are presented. Preferably, the results are presented in order of how closely they match the given criteria.

The lending individual 1-10a and borrowing individual 1-10b, at 2-12, then review the results and select a borrowing request or lending bid that appears most attractive to them, if any. For ease of description, it will be assumed that the lending bid created by the lending individual 1-10a is matched most closely with the borrowing request of the borrowing individual 1-10b, and the lending individual 1-10a has chosen to initiate negotiations with the borrowing individual 1-10b. It is to be understood, however, that the borrowing individual 1-10b may also initiate negotiations.

Steps 2-14, 2-16, 2-18, 2-20, 2-22, and 2-24 represent the process of negotiation between the lending individual 1-10a and borrowing individual 1-10b.

In its simplest form, the negotiation process involves the lending individual 1-10a progressing from 2-12 straight to accepting the borrowing individual's borrowing request (2-20), then subsequently to notifying the borrower (2-22), and ending in both the lending individual 1-10a and borrowing individual 1-10b accepting the loan (2-24).

However, it may be the case that either of the lending individual 1-10a and/or borrowing individual 1-10b may desire to negotiate one or more terms and/or request more information. In this case, the process proceeds to 2-14 and 2-16 where the other party is notified of a desire by a first party for further negotiations. The notification of a desire for negotiations is sent to the other party together with specifics of what changes are desired. Negotiable changes may include changes to any of the aforementioned lending or borrowing characteristics, request for further verification of identity or other personal circumstances (e.g. financial, criminal, etc.), and the like. In the preferred embodiment, the record of all negotiations is stored electronically in the document database 1-6.

At any time during the negotiation process, either of the lending individual 1-10a or borrowing individual 1-10b may withdraw from negotiations and reject the match, or choose to finalize negotiations. Rejection or acceptance of the terms and conditions of loan is performed at 2-20.

At 2-20, if the terms as offered or negotiated by one party are not acceptable by the other party, the loan may be rejected by the other party, and the process 2000 progress to 2-22 where the other party is duly notified, and the process 2000 ends. Conversely, if the terms as offered or negotiated by one party are acceptable by the other party, the loan is accepted by the other party, and the process 2000 progresses to 2-22 where the other party is duly notified. The process 2000 in this case progresses to 2-24.

At 2-24, formal acceptance of the loan by both the lending individual 1-10a and borrowing individual 1-10b is executed. Formal acceptance of the loan, in the preferred embodiment, is executed as an electronic indication of acceptance on an appropriate electronic document containing the terms and other conditions of the loan. For example, the electronic indication may be provided by way of digital signatures and/or selection of a check box, on an online form, portable document format (PDF) document, webpage, and the like. The electronic document containing the electronic indications is then stored in the document database 1-6.

Preferably, at 2-24, financial details to effect the transfer of funds between the lending individual 1-10a and the borrowing individual 1-10b are also provided to both parties. The financial details exchanged include, for example, bank account details, PayPal™ details, credit card details, and the like.

At 2-26, based on the terms and conditions of the accepted loan, the system 1000 schedules repayments to be made by the borrowing individual 1-10b to the lending individual 1-10b. The scheduled repayments are calculated based on one or more of the repayment terms specified in the terms of the accepted loan, the date of acceptance of the loan, amount of the loan, and the like. The scheduled repayments, in the preferred embodiment, are saved to both the lending individual's and borrowing individual's user account as electronic notification reminders operable to generate push notifications on the lending device 1-8a and borrowing device 1-8b at predetermined times prior to and/or at each repayment due date. The scheduled repayments may additionally be provided to the lending individual 1-10a and/or borrowing individual 1-10b in a standard calendar format, such as ICS or iCAL.

At 2-28, prior to and/or at each repayment due date, the lending individual 1-10a and/or borrowing individual 1-10b are notified of the imminent repayment due date.

At 2-30, repayments as scheduled are made by the borrowing individual 1-10b to the lending individual 1-10a. Repayments may be made from the borrowing individual 1-10b to lending individual 1-10a by means independent of the system 1000, such as through electronic fund transfers directly via the financial systems 1-12a, 1-12b of the financial institutions, cash payments, PayPal™, credit card, cheque, and the like. In the preferred embodiment, however, repayment are made via the financial systems 1-12a, 1-12b through the portal 1-4. Using the portal 1-4 to effect repayments via the financial systems 1-12a, 1-12b, rather than directly using the financial systems 1-12a, 1-12b, allows the system 1000 to record confirmation/rejection of repayments, date of repayments, and the like in the document database 1-6.

If all repayments are made on time and in full, the loan is discharged (2-36). Both the borrowing individual 1-10b and the lending individual 1-10a then have an opportunity to rate each other, and either increase or decrease respective lending and borrowing ratings, as appropriate. Lending and borrowing ratings, in contrast with official credit ratings and security ratings, are specific to the system 1000 and provide a means by which users of the system can informally rate each other.

If one or more repayments are not made on time or in full, the lending individual 1-10a and/or the borrowing individual 1-10b are notified of the missed repayment at 2-32.

At 2-34, the system 1000 may automatically generate a new schedule of repayments and impose fees or other charges, in accordance with the relevant terms of the loan pertaining to missed repayments, if specified. Alternatively, if sufficient detail is not available in the terms and conditions of the loan to allow the system 1000 to automatically take appropriate action, negotiations are commenced between the lending individual 1-10a and borrowing individual 1-10b to revise and set new terms and conditions.

If new terms and conditions are mutually agreed to, and adhered to, the process 2000 returns to 2-30 where repayments are made in accordance with the new terms and conditions until such time as the loan is discharged.

Conversely, if new terms and conditions are not mutually agreed to, and/or if any such new terms and conditions are not adhered to, the loan is terminated and the lending individual 1-10a and/or borrowing individual 1-10b may refer the matter to one or more dispute resolution entities 1-14. Both the lending individual 1-10a and borrowing individual 1-10b then also have the opportunity to rate each other, and increase or decrease lending and borrowing ratings of the other party.

All correspondences, draft documents, and final documents exchanged between the lending individual 1-10a and borrowing individual 1-10b, and all activities conducted by both such individuals 1-10a, 1-10b on the system 1000 or facilitated by the portal 1-4 in relation to the loan is, in the preferred embodiment, recorded in the document database 1-6. In this manner, an evidence trail is available for the purposes of resolving disputes, should such arise.

When a matter is referred to a dispute resolution entity 1-14, the information recorded in the document database 1-6 (e.g. correspondences, documents, activity history, etc.) can be made available to the dispute resolution entity 1-14. In the preferred embodiment, the dispute resolution entity 1-14 is engaged by either one or both of the lending individual 1-10a and borrowing individual 1-10b through the system 1000. In this manner, record of the engagement such as correspondences and the like may also be recorded in the document database 1-6. Alternatively, the lending individual 1-10a and borrowing individual 1-10b may separately and independently engage dispute resolution entities from outside of the system 1000.

The records stored in the document database 1-6 may be set with default permissions allowing or preventing access thereto by various dispute resolution entities. In one embodiment, once a dispute resolution entity is engaged by an individual 1-10a, 1-10b through the system 1000, the system 1000 records an identity of the dispute resolution entity as an approved entity for accessing records in the document database 1-6 pertaining to the loan in dispute. The access given to the dispute resolution entity may further be dependent on the type of service the entity provides, the party the entity is representing, any registrations/licenses held by the entity, and the like.

The system 1000 and process 2000 of the present invention is configured and adapted to match lending individuals 1-10a with borrowing individuals 1-10b, so as to facilitate financial loans between the two individuals. The provision of the document database 1-6 as part of the system 1000 to record all correspondences between individuals provides a level of security and confidence for both the lending individual 1-10a and borrowing individual 1-10b, and acts as a source of evidence should a dispute occur between the lending and borrowing individuals 1-10a, 1-10b. The effect of the document database 1-6, together with peer-assessed lending ratings and borrowing ratings for each individual, encourage all users of the system 1000 to act honestly, transparently, and in good faith.

### ADVANTAGES

The present invention allows individuals to lend and borrow money on a peer-to-peer basis, without the involvement of a large financial institution to finance the loan. Accordingly, loans that are better suited to individual circumstances can be negotiated and obtained between individuals. The present invention further provides a new way for individuals with savings to generate additional income from their savings.

With the provision of a central database to record all relevant correspondences, a level of security for lending and borrowing individuals is provided that is not available in present peer-to-peer lending arrangements.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A peer-to-peer loan facilitation system, the system comprising:
a first electronic device configured to create a lending bid or borrowing request, the lending bid or borrowing request specifying one or more terms and conditions for the provision of a financial loan;
a second electronic device configured to generate a search criteria for a lending bid or a borrowing request, the search criteria including one or more terms and conditions for the provision of a financial loan;
a server configured to receive from the first electronic device the lending bid or borrowing request, receive from the second electronic device the search criteria, and match the search criteria to the lending bid or borrowing request if the one or more terms and conditions of the search criteria are similar to those of the lending bid or borrowing request, wherein the server is further configured to facilitate the exchange of electronic correspondence between the first electronic device and the second electronic device; and
a database connected to the server and configured to record therein the electronic correspondences exchanged between the first electronic device and the second electronic device.

2. A peer-to-peer loan facilitation system as claimed in claim 1, wherein the server is further configured to generate a repayment schedule, the repayment schedule identifying one or more of the date and sum of each repayment to be made in accordance with the terms and conditions of the lending bid, and wherein the repayment schedule is stored in one or more of the first electronic device and second electronic device as an electronic reminder for each repayment.

3. A peer-to-peer loan facilitation system as claimed in claim 1, wherein there is a portal connected to the server, the portal connecting the first electronic device and second electronic device to one or more financial systems, whereby a transfer of funds between a lender and a borrower is facilitated.

4. A peer-to-peer loan facilitation system as claimed in claim 1, wherein the second electronic device is operable to send to the first electronic device, via the server, an electronic correspondence indicative of an acceptance of the lending bid created by the first electronic device.

5. A peer-to-peer loan facilitation system as claimed in claim 1, wherein the second electronic device is operable to send to the first electronic device, via the server, an electronic correspondence proposing revisions to the one or more terms and conditions specified by the lending bid created by the first electronic device.

6. A peer-to-peer loan facilitation system as claimed in claim 1, wherein the first electronic device is operable to send to the second electronic device, via the server, an electronic correspondence indicative of an acceptance of the borrowing request created by the second electronic device.

7. A peer-to-peer loan facilitation system as claimed in claim 1, the first electronic device is operable to send to the second electronic device, via the server, an electronic correspondence proposing revisions to the one or more terms and conditions specified by the borrowing request created by the second electronic device.

8. A peer-to-peer loan facilitation system as claimed in claim 1, wherein the search criteria generated by the second electronic device is in the form of a lending bid or borrowing request.

9. A peer-to-peer loan facilitation system as claimed in claim 1, wherein upon identification of a deviation from the repayment schedule, the server generates a new schedule of repayments, the new schedule being generated based on the one or more terms and conditions.

10. A peer-to-peer loan facilitation system as claimed in claim 1, wherein upon identification of a deviation from the repayment schedule, the server notifies the first electronic device and the second electronic device of the deviation, and facilitates communication between the first and second electronic devices to revise the one or more terms and conditions.

11. A peer-to-peer loan facilitation system as claimed in claim 1, wherein there are one or more dispute resolution entities connected to the facilitation server;
said facilitation server generates and stores therein user accounts for each of the borrowing individuals, the lending individuals, and the one or more dispute resolution entities; the user accounts for the lending and borrowing individuals each record information relevant to and likely required for the provision and/or acceptance of a loan including name, address, age, contact details, bank account details, proof of credit history, proof of identity, criminal history, verified digital signatures, lending rating, and borrowing rating; the user accounts for the one or more dispute resolution entities record one or more of contact details for the entities, access rights to the document database, services offered, and reputation rating.

12. A peer-to-peer loan facilitation system as claimed in claim 11, wherein the facilitation server further stores, in association with each user account, one or more lending bids or borrowing requests as they are created by respective users; each lending bid stipulates the terms and conditions on which a lending individual will provide a loan; each borrowing request stipulates the terms and conditions on which a borrowing individual wants a loan; the facilitation server is configured to match lending bids and borrowing requests that have similar terms and conditions; the facilitation server is operable to search lending bids and borrowing requests stored therein on demand by users and in accordance with one or more search criteria set by the users.

13. A peer-to-peer loan facilitation system as claimed in claim 11, wherein the transaction portal is provided by the facilitation server and serves to connect the electronic financial systems with the lending and borrowing individuals from within the loan facilitation system; the transaction portal integrates the electronic financial systems with the loan facilitation system, thereby removing the need for the lending individual and borrowing individual to leave the loan facilitation system to separately access the electronic financial systems; the portal in integrating the electronic financial systems with the loan facilitation system, allows records/receipts of financial transactions conducted between the lending individual, borrowing individual, and electronic financial systems to be recorded in the database.

14. A peer-to-peer loan facilitation system as claimed in claim 13, wherein the database records therein information exchanged between the lending individual, borrowing individual, and electronic financial systems (where available) in the setup, conduct, and discharge of a loan between the lending individual and borrowing individual; the information recorded in the database serves as one source of a paper trail and proof of a loan arrangement between the lending individual and the borrowing individual and information recorded in the database is assigned one or more security settings, which security settings determines which of the one or more dispute resolution entities assigned to a dispute resolution event may access said information if/when a dispute resolution event is commenced.

15. A peer-to-peer loan facilitation system as claimed in claim 14, wherein the records stored in the database are set with default permissions allowing or preventing access thereto by various dispute resolution entities; wherein when a dispute resolution entity is engaged by an individual through the system, the system records an identity of the dispute resolution entity as an approved entity for accessing records in the database pertaining to the loan in dispute;
the access given to the dispute resolution entity depends on the type of service the entity provides, the party the entity is representing, and any registrations/licenses held by the entity.

16. A peer-to-peer loan facilitation system as claimed in claim 15, wherein the system is configured and adapted to match lending individuals with borrowing individuals, so as to facilitate financial loans between the two individuals; the provision of the database as part of the system to record all correspondences between individuals provides a level of security and confidence for both the lending individual and borrowing individual, and acts as a source of evidence should a dispute occur between the lending and borrowing individuals.

17. A peer-to-peer loan facilitation system as claimed in claim 15, wherein borrowing individual and the lending individual have an opportunity to rate each other at different stages of their interaction and the ratings are recorded for others to consider when they are wishing to financially interact with either of the individuals.

18. A peer-to-peer loan facilitation system as claimed in claim 15, wherein the use of the database and a peer-assessed lending ratings and borrowing ratings for each individual, provides a system where transactions and interactions are transparent for all users.

19. A peer-to-peer lending process, the process comprising the steps of:
generating a lending bid or borrowing request on a first electronic device, the lending bid or borrowing request specifying one or more terms and conditions for the provision of a financial loan;
generating a search criteria for a lending bid or a borrowing request, the search criteria including one or more terms and conditions for the provision of a financial loan;
receiving the lending bid or borrowing request and the search criteria at a server, and matching in the server the lending bid or borrowing request to the search criteria if the one or more terms and conditions of the search criteria are similar to those of the lending bid or borrowing request;
exchanging electronic messages between the first electronic device and second electronic device via the server, and recording the electronic messages in a database; and
transferring funds between an operator of the first electronic device and an operator of the second electronic device, whereby a financial loan between the operator of the first electronic device and the operator of the second electronic device is effected.

20. A peer-to-peer lending process as claimed in claim 19, wherein there is a step of generating a repayment schedule, the repayment schedule identifying one or more of the date and sum of each repayment to be made in accordance with the terms and conditions of the lending bid, and storing in one or more of the first electronic device and second electronic device an electronic reminder for each repayment.
